(19) United States
(12) Patent Application Publication
(10) Pub. No.: US 2006/0115349 A1
(43) Pub. Date: Jun. 1, 2006

(54) Fork positioner

(76) Inventor: Glenn Prentice, Milwaukie, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/000,783

(22) Filed: Nov. 30, 2004

(51) Int. Cl. A01D 85/00

(52) U.S. Cl. 414/24.5

(57) ABSTRACT

A fork positioner, usable alternatively either as an attachment to an existing load-lifting carriage with forks, or as part of the original equipment of a load-lifting carriage, has a pair of elongate hydraulic piston and cylinder assemblies mountable in an interconnected parallel relationship between an upper transverse fork-supporting member and a lower transverse member of the carriage. Each of a pair of fork-positioning guide members has a fork-engagement surface movable by a respective piston and cylinder assembly and connectable thereto so that the fork-engaging surfaces face substantially perpendicularly away from an imaginary plane containing the respective longitudinal axes of the piston and cylinder assemblies. An exemplary carriage mounting the fork positioner is also disclosed.

### BACKGROUND OF THE INVENTION

This invention relates to a fork positioner for moving the load-lifting forks of a lift truck carriage selectively toward or away from each other so as to change their transverse separation. More particularly, the invention relates to a fork positioner which can be attached to an existing lift truck carriage, or incorporated as original equipment in a newly-manufactured carriage.

Fork positioners actuated by pairs of hydraulic cylinders, motor-driven screws, or the like have been used extensively on fork-supporting lift truck carriages. Most of these fork positioners are furnished as integral components of a carriage, often in combination with a side-shifting function which enables the carriage to be moved transversely so as to side-shift the forks in unison. Some detachably-mountable fork positioners have been provided in the past, such as those shown in U.S. Pat. Nos. 4,756,661, 4,902,190 and 6,672,823, to enable existing lift truck carriages without fork-positioning capability to be provided with such capability. However such detachably-mounted side-shifters have in the past increased the dimensions of the lift truck carriage, either horizontally as shown in U.S. Pat. No. 4,756,661 which reduces the load-carrying capacity of a counterbalanced lift truck by moving the load forward, or vertically as shown in U.S. Pat. Nos. 4,902,190 and 6,672,823 which impairs the lift truck operator's visibility over the top of the carriage.

### BRIEF SUMMARY OF THE INVENTION

A need therefore exists for a highly-compact fork positioner which does not require such increased dimensions, does not significantly impair operator visibility, and is easy to mount on existing carriages or newly-manufactured carriages. 004 The foregoing and other objectives, features, and advantages of the invention will be more readily understood upon consideration of the following detailed description taken in conjunction with the accompanying drawings.

### BRIEF DESCRIPTION OF THE SEVERAL DRAWINGS

FIG. 1 is a perspective view of an exemplary embodiment of a fork positioner in accordance with the present invention, shown prior to mounting on a load-lifting carriage.

FIG. 2 is a front view of an exemplary load-lifting carriage mounting the fork positioner of FIG. 1.

FIG. 3 is a rear view of the carriage of FIG. 2.

FIG. 4 is a partially sectional side view of the carriage of FIG. 2, taken along line 44.

FIG. 5 is an enlarged rear detail view of a center portion of the fork positioner of FIG. 1 showing interior hydraulic conduits.

FIG. 6 is an enlarged rear detail view of a center portion of the fork positioner of FIG. 1 showing other interior hydraulic conduits.

FIG. 7 is an enlarged rear detail view of a base portion of one of the piston and cylinder assemblies of the fork positioner of FIG. 1.

### DETAILED DESCRIPTION OF PREFERRED EMBODIMENTS

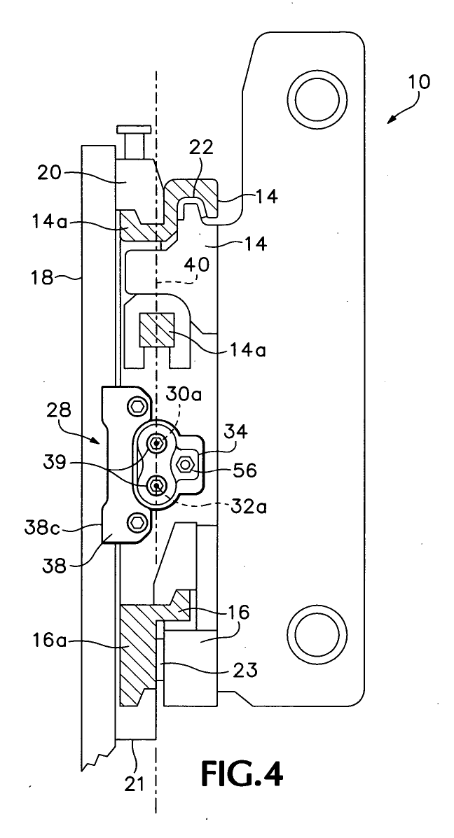

FIGS. 24 show an exemplary embodiment of a load-lifting carriage 10 mountable for vertical movement on the mast of an industrial lift truck (not shown). The carriage 10 can be any of numerous different types, usually having an upper transverse fork-supporting member such as 14 and a lower transverse member such as 16 mounting two or more load-lifting forks such as 18 by means of fork hooks 20, 21 (FIG. 4) slidably engaged for transverse movement by hook portions 14a and 16a, respectively, of upper member 14 and lower member 16. The hook portions 14a and 16a may be integral parts of the upper member 14 and lower member 16 respectively if the carriage 10 is of a simple standard type. Alternatively, the hook portions 14a and 16a may be transversely movable relative to the remainder of the upper member 14 and lower member 16 on slide bushings such as 22, 23 (FIG. 4) under the control of a bidirectional side-shifting hydraulic piston and cylinder assembly 24 interacting between a side-shifting frame 25 containing the hook portions 14a, 16a, and the remainder of the carriage 10. Such a side-shifting frame 25 enables the forks 18 to be moved transversely in unison if desired.

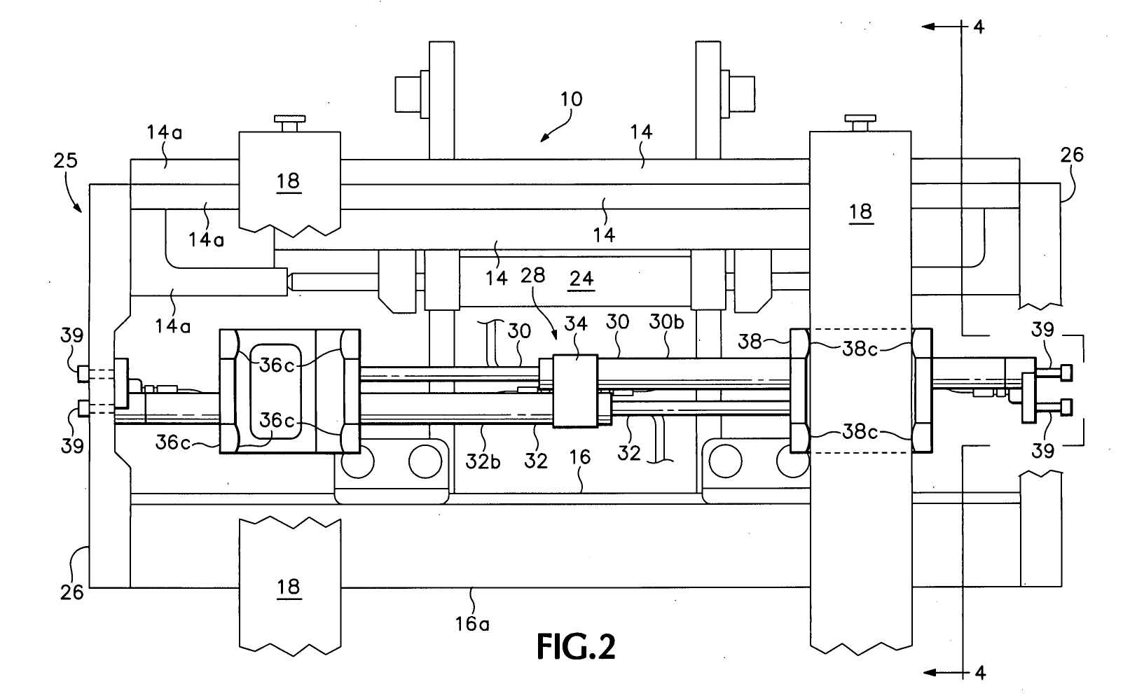

As shown in FIG. 2, the upper hook portion 14a and lower hook portion 16a of the carriage 10 are joined by respective end members 26 of the frame 25 which side-shift transversely in unison with the hook portions 14a, 16a and the forks 18. Alternatively, if the carriage 10 is not of the side-shifting type, such end members 26 can join the upper member 14 and lower member 16 of a standard carriage.

If the carriage 10 is of the side-shifting type, its side-shifting piston and cylinder assembly 24 is preferably located immediately beneath, rather than above, the upper member 14 to maximize the operator's visibility over the top of the carriage when the carriage is lowered, and to leave an open space between the side-shifting piston and cylinder assembly 24 and the lower member 16 for enhanced operator visibility through the center of the carriage.

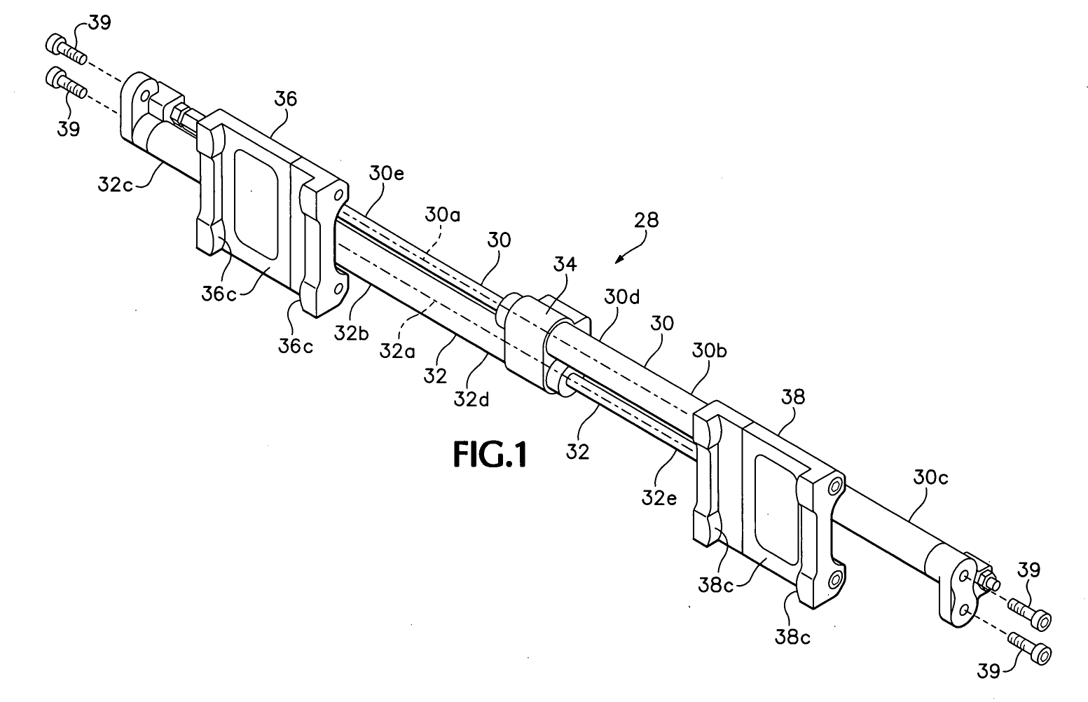

It is often desirable that the carriage 10, whether or not of the side-shifting type, be provided with a fork positioner for enabling the forks 18 to be selectively moved toward or away from each other so as to adjust the transverse spacing between them. To provide this function, a unique fork positioner indicated generally as 28 is disclosed in FIG. 1. The fork positioner 28 may either be conveniently mounted to an existing carriage 10 having no fork-positioning capability or, alternatively, included as part of a carriage 10 as originally manufactured. The fork positioner 28 includes a pair of elongate, bidirectional hydraulic piston and cylinder assemblies 30 and 32 having respective longitudinal axes 30a, 32a (FIG. 1) and each having a respective cylinder 30b, 32b with a respective base portion 30c, 32c at one end and a respective rod end portion 30d, 32d at the other end from which a respective piston rod 30e, 32e is extensible along a respective axis 30a, 32a. A cylinder connector 34 is adapted to threadably interconnect the rod end portion 30d of one cylinder rigidly to the rod end portion 32d of the other cylinder so that the axes 30a and 32a are parallel to each other. When the cylinders are interconnected in this manner, the piston rod 30e, 32e of each of the pair of piston and cylinder assemblies is extensible into longitudinally-overlapping relationship to the cylinder of the other piston and cylinder assembly as shown in FIG. 1.

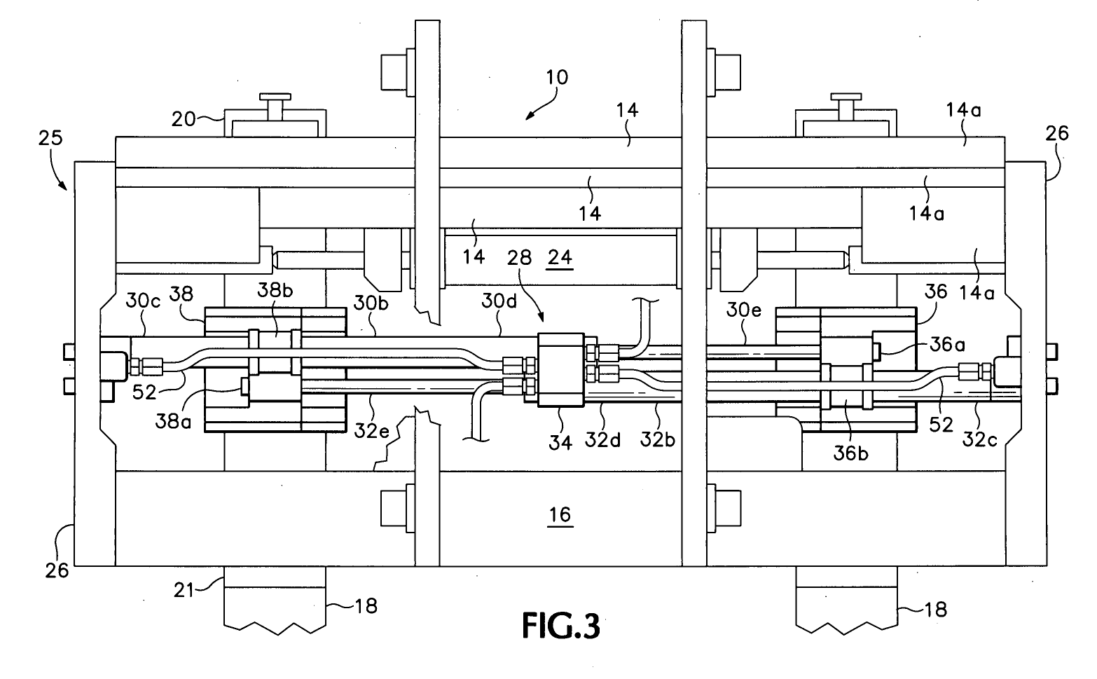

A pair of fork-positioning guide members 36, 38 each connects to a respective piston rod 30e, 32e by means of a respective rod connector 36a, 38a (FIG. 3) while also slidably and guidably engaging the respective cylinder 32b, 30b of the opposite piston and cylinder assembly by a respective slide bushing 36b, 38b. This arrangement enables a recessed fork-engagement surface 36c, 38c (FIG. 1) of each respective guide member to face away from the respective longitudinal axes 30a, 32a of the piston and cylinder assemblies in a forward direction substantially perpendicular to an imaginary plane 40 (FIG. 4) containing both of the longitudinal axes 30a and 32a. When the fork positioner 28 is mounted on the carriage 10, the plane 40 also interconnects the upper transverse member 14 and lower transverse member 16 since the piston and cylinder assemblies 30 and 32 are inserted between the members 14 and 16.

When the fork positioner 28 has been mounted to the carriage in an inserted position between the upper member 14 and the lower member 16 as shown in the figures, the piston and cylinder assemblies 30 and 32 can move the guide members 36 and 38 selectively toward and away from each other. Fork positioning force is applied by the guide members 36, 38 to the sides of the respective forks 18 in a substantially direct, nonbinding fashion so that the forks slide easily toward and away from each other along the upper transverse fork-supporting member 14. To maximize this nonbinding force transmission, the fork-engaging surfaces 36b, 38b are preferably vertically coextensive with at least a major portion of the distance separating the respective longitudinal axes 30, 32a of the piston and cylinder assemblies.

In order to provide easy mounting of the fork positioner on the carriage 10 in its inserted position between the upper member 14 and lower member 16, the piston and cylinder assemblies 30 and 32 are preferably mountable on the carriage 10 while interconnected with each other as a unit, for example by the cylinder connector 34 and/or the fork-positioning guide members 36, 38. This unitized insertable fork positioner package requires no unitizing framework other than the piston and cylinder assemblies themselves and, if desired, also the fork-positioning guide members. The resultant rigid, essentially frameless fork positioner unit is thus so compact that it can be mounted in its inserted position centrally on the carriage 10 without significantly impairing the operator's visibility, or altering the dimensions of the carriage 10 in a way that would push the load forwardly and thereby reduce the load-carrying capacity of the lift truck. Moreover, mounting of the fork positioner on the carriage is greatly simplified by the unitized nature of the fork positioner, and by the fact that only the piston and cylinder assemblies 30, 32 must be supportably connected to the carriage 10 since the fork-positioning guide members 36, 38 are supportable by the piston and cylinder assemblies 30, 32 independently of any engagement by either guide member with a fork 18.

One possible easy mounting arrangement for the piston and cylinder assemblies 30 and 32 is to connect the respective base portions 30c, 32c of the cylinders to respective end members 26 of the carriage 10 by screws 39 as shown in the drawings or by any other convenient means. If an existing carriage 10 has no such end members, they can easily be added to the carriage as part of the assembly process. Alternatively, the piston and cylinder assemblies 30a, 32a could be more centrally mounted to the carriage 10 by one or more brackets attached to the carriage upper member 14 or 14a in a manner which does not significantly impair operator visibility through the center of the carriage.

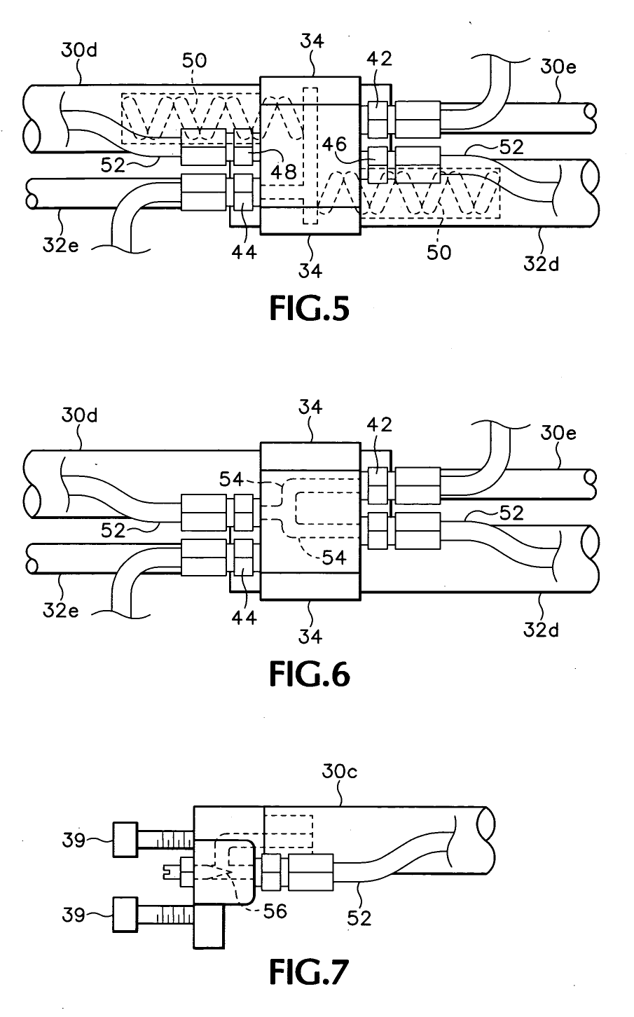

Preferably, the cylinder connector 34 includes one or more hydraulic fluid line connectors 42, 44, 46, 48 communicating with the interiors of the respective cylinders 30b, 32b. For example, one such connector 44 (FIG. 5) can introduce pressurized fluid simultaneously to the rod end portions 30d, 32d of the cylinders through internal spiral conduits 50 to retract the piston rods 30e, 32e simultaneously, while another connector 42 (FIG. 6) communicating with interior conduits 54 and exterior conduits 52 can exhaust hydraulic fluid simultaneously from the base portions 30c, 32c of the cylinders. Respective conventional flow equalizer valves such as 56 (FIG. 7) in each base portion 30c, 32c achieve uniform movement of the piston rods. An operator control valve (not shown) can reverse the flows of pressurized fluid and exhaust fluid through connectors 42 and 44 respectively to similarly extend the piston rods.

Although the preferred form of the fork positioner utilizes piston and cylinder assemblies wherein each cylinder 30b, 32b is connected to the carriage 10 so as to prevent the cylinder's longitudinal movement relative to the carriage, a reversed structure wherein piston rods are connected to the carriage so that their cylinders can move the fork-positioning guide members would also be within the scope of the invention.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A fork positioner mountable on a load-lifting carriage having an upper transverse fork-supporting member and a lower transverse member, said fork positioner comprising:
(a) a pair of elongate hydraulic piston and cylinder assemblies having respective longitudinal axes, said piston and cylinder assemblies being interconnectable to each other and mountable to said carriage in an inserted position so that said respective longitudinal axes extend transversely to said carriage in a substantially parallel relationship between said upper transverse fork-supporting member and said lower transverse member; and
(b) a pair of fork-positioning guide members, each having a fork-engagement surface movable by one of said pair of piston and cylinder assemblies and movably guidable by the other of said pair of piston and cylinder assemblies when said assemblies are interconnected in said inserted position, so that each said fork-engagement surface faces away from said piston and cylinder assemblies in a direction substantially perpendicular to an imaginary plane containing said respective longitudinal axes.

2. The fork positioner of claim 1, said pair of piston and cylinder assemblies being mountable to said carriage in said inserted position as a unit when said piston and cylinder assemblies are interconnected to each other with said respective longitudinal axes in said parallel relationship.

3. The fork positioner of claim 1 wherein said pair of guide members are supportable by said pair of piston and cylinder assemblies, independently of any engagement by said guide members with a fork, when said pair of piston and cylinder assemblies are interconnected to each other and mounted to said carriage in said inserted position.

4. The fork positioner of claim 1 wherein said fork positioner is mountable on a load-lifting carriage having respective end members joining said upper transverse fork-supporting member and said lower transverse member, said piston and cylinder assemblies being mountable between said end members in said inserted position so as to be supported by said end members.

5. A fork positioner mounted on a load-lifting carriage having an upper transverse fork-supporting member and a lower transverse member, said fork positioner comprising:
(a) a pair of elongate hydraulic piston and cylinder assemblies having respective longitudinal axes, said piston and cylinder assemblies being interconnected to each other and mounted to said carriage in a mounted position so that said respective longitudinal axes extend transversely to said carriage in a substantially parallel relationship between said upper transverse fork-supporting member and said lower transverse member; and
(b) a pair of fork-positioning guide members, each having a fork-engagement surface movable by one of said pair of piston and cylinder assemblies and movably guided by the other of said pair of piston and cylinder assemblies so that each said fork-engagement surface faces away from said piston and cylinder assemblies in a direction substantially perpendicular to an imaginary plane containing said respective longitudinal axes.

6. The fork positioner of claim 5 wherein said pair of guide members are supported by said pair of piston and cylinder assemblies, independently of any engagement by said guide members with a fork.

7. The fork positioner of claim 5 wherein said carriage includes respective end members joining said upper transverse fork-supporting member and said lower transverse member, said piston and cylinder assemblies being mounted between said end members so as to be supported by said end members.

8. A fork positioner mountable on a load-lifting carriage having an upper transverse fork-supporting member and a lower transverse member, said fork positioner comprising:
(a) a pair of elongate hydraulic piston and cylinder assemblies, having respective longitudinal axes and each having a cylinder with a base portion at one end and a rod end portion at the other end from which a piston rod is extensible along said respective longitudinal axes;
(b) a cylinder connector adapted to connect the rod end portion of one said cylinder to the rod end portion of the other said cylinder in a longitudinally-opposed, axially parallel interconnected relationship to each other;
(c) the piston rod of each of said piston and cylinder assemblies being extensible into longitudinally-overlapping relationship to the cylinder of the other of said pair of piston and piston assemblies when each rod end portion is connected to the other rod end portion in said interconnected relationship;
(d) a pair of fork-positioning guide members each having a fork-engagement surface, each piston rod being connectable to a respective one of said guide members so that said fork-engagement surface faces away from said respective longitudinal axes of said piston and cylinder assemblies in a direction substantially perpendicular to an imaginary plane containing said respective longitudinal axes when each rod end portion is in said interconnected relationship;
(e) each said cylinder being connectable by a mounting structure to said carriage when each rod end portion is in said interconnected relationship so that said carriage can support said pair of piston and cylinder assemblies in an inserted position between said upper transverse fork-supporting member and said lower transverse member while preventing longitudinal movement of each cylinder relative to said carriage, said pair of piston and cylinder assemblies being insertable as a unit into said inserted position when each rod end portion is in said interconnected relationship.

9. The apparatus of claim 8 wherein said rod end portions of said cylinders are rigidly interconnectable by said cylinder connector.

10. The apparatus of claim 8 wherein said mounting structure is connectable to said carriage so that said respective longitudinal axes of said piston and cylinder assemblies when in said inserted position are located at different distances from said upper transverse fork-supporting member and said lower transverse member of said carriage.

11. The apparatus of claim 8 wherein said pair of guide members are supportable by said pair of piston and cylinder assemblies, independently of any engagement by said guide members with a fork, when said pair of piston and cylinder assemblies are supported by said carriage in said inserted position.

12. The apparatus of claim 8 wherein said cylinder connector includes at least one hydraulic fluid line connector communicating with a respective cylinder.

13. The apparatus of claim 8 wherein said cylinder connector includes multiple hydraulic fluid line connectors communicating with a respective cylinder.

14. The apparatus of claim 8 wherein said cylinder connector includes at least one hydraulic fluid line connector communicating with each cylinder.

15. The apparatus of claim 8 wherein said cylinder connector includes multiple hydraulic fluid line connectors communicating with each cylinder.

16. The fork positioner of claim 8 wherein said fork positioner is mountable on a load-lifting carriage having respective end members joining said upper transverse fork-supporting member and said lower transverse member, said piston and cylinder assemblies being mountable between said end members in said inserted position so as to be supported by said end members.

17. A fork positioner mounted on a load-lifting carriage having an upper transverse fork-supporting member and a lower transverse member, said fork positioner comprising:
(a) a pair of elongate hydraulic piston and cylinder assemblies having respective longitudinal axes and each having a cylinder with a base portion at one end and a rod end portion at the other end from which a piston rod is extensible along said respective longitudinal axes;
(b) the rod end portion of one said cylinder being interconnected with the rod end portion of the other said cylinder in a longitudinally-opposed, axially parallel interconnected relationship to each other;
(c) the piston rod of each of said pair of piston and cylinder assemblies being extensible into longitudinally-overlapping relationship to the cylinder of the other of said pair of piston and cylinder assemblies;
(d) a pair of fork-positioning guide members each having a fork-engagement surface, each piston rod being connected to a respective one of said guide members so that said fork-engagement surface faces away from said respective longitudinal axes of said piston and cylinder assemblies in a direction substantially perpendicular to an imaginary plane containing said respective longitudinal axes;
(e) each said cylinder being connected to said carriage so that said carriage supports said pair of piston and cylinder assemblies between said upper transverse fork-supporting member and said lower transverse member while preventing longitudinal movement of each cylinder relative to said carriage.

18. The apparatus of claim 17 wherein said rod end portions of said cylinders are rigidly interconnected.

19. The apparatus of claim 17 wherein said respective longitudinal axes of said piston and cylinder assemblies are located at different distances from said upper transverse fork-supporting member and said lower transverse member of said carriage.

20. The apparatus of claim 17 wherein said pair of guide members are supported by said pair of piston and cylinder assemblies independently of any engagement by said guide members with a fork.

21. The apparatus of claim 17 wherein said cylinder connector includes at least one hydraulic fluid line connector communicating with a respective cylinder.

22. The apparatus of claim 17 wherein said cylinder connector includes multiple hydraulic fluid line connectors communicating with a respective cylinder.

23. The apparatus of claim 17 wherein said cylinder connector includes at least one hydraulic fluid line connector communicating with each cylinder.

24. The apparatus of claim 17 wherein said cylinder connector includes multiple hydraulic fluid line connectors communicating with each cylinder.

25. The apparatus of claim 17 wherein said load-lifting carriage has a transverse elongate side-shifting hydraulic piston and cylinder assembly connected thereto in a position between said upper transverse fork-supporting member and said pair of piston and cylinder assemblies.

26. The fork positioner of claim 17 wherein said carriage includes respective end members joining said upper transverse fork-supporting member and said lower transverse member, said piston and cylinder assemblies being mounted between said end members so as to be supported by said end members.
